(19) United States
(12) Patent Application Publication
(10) Pub. No.: US 2016/0342746 A1
(43) Pub. Date: Nov. 24, 2016

(54) Cloud-Based Medical-Terminology Manager and Translator

(71) Applicants: Naveen Sarabu, Cary, NC (US); Gary Palgon, Dunwoody, GA (US); David Shengchu Liu, Franklin, TN (US); Tongqing Qiu, Cumming, GA (US)

(72) Inventors: Naveen Sarabu, Cary, NC (US); Gary Palgon, Dunwoody, GA (US); David Shengchu Liu, Franklin, TN (US); Tongqing Qiu, Cumming, GA (US)

(21) Appl. No.: 14/718,274

(22) Filed: May 21, 2015

(51) Int. Cl. G06F 19/00; G06F 17/30

(52) U.S. Cl. CPC G06F 19/324; G06F 17/30914; G06F 17/30289

(57) ABSTRACT

A medical terminology management and translation system that is cloud-based, on-demand, and allows semantic translations of medical terminologies and corresponding healthcare controlled medical vocabularies. A multiple-layer domain structure is provided for the database that designates whether data is to be added or changed, locates where the data exists in the database, and presents the new or substituted data. A semantic data structure and process calculates the probability that an entry matches the particular terminology in a database library and uses the most likely correct answer. Concepts are also employed for particular terminology, handling terms with two or more meanings, and the terminology is mapped according to the concept.

### CROSS-REFERENCE TO RELATED APPLICATIONS

Not Applicable

### STATEMENT REGARDING FEDERALLY SPONSORED RESEARCH OR DEVELOPMENT

Not Applicable THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates generally to the field of medical terminology management and translation, and more particularly to a cloud-based on-demand software system that provides management and semantic translations of medical terminologies and corresponding healthcare controlled medical vocabularies.

2. Background Art

There are numerous types of medical terminology, vocabularies and codes used in the medical industry, and various products have sought to provide means for managing and translating between different “standards” for medical terminology, vocabularies and codes for different use cases and application areas. Examples of such medication terminology include pharmaceuticals and their dosages, diagnoses, treatments, medical tests and procedures, surgery, and so forth. Terminology differs between different areas. For example, RxNorm mapping from other drug terminologies, ICD10 mapping from other procedures and diagnosis terminologies, LOINC mapping from different local and standard lab results terminologies, and SNOMED CT from other problems terminologies. Such medical translation is routinely needed by doctors, nurses, pharmacists, insurance personnel and other administrators. Large terminology books have been sold that allow the reader to look up various medical language vocabularies and codes for different purposes, allowing translation between different standards. These books are bulky—there are more than one million different terminologies and codes—expensive and time consuming to use. They also become out of date almost immediately upon publication as new terminology is added, or terminology or codes are changed. Maintaining and managing these terminologies is crucial for properly documenting patient data.

More recently, software has been developed to speed up the process of translating from one type of medical terminology to another and/or between different versions of the same vocabulary. Such software, however, is costly, and includes a very large library of the various terminologies used in all medical specialties. These software packages require the user to purchase the entire library when they are only interested in a small portion. They also require the software to be housed on or accessible by all computers used by practitioners and their staff.

The software packages also require constant updating such as when new drugs are added, dosages change, or other information or terminology is changed. Often practitioners and other users of the software use out-of-date terminology.

Finally, existing software performs searches and translations only when exactly the correct words and numerals are used, in the right order. A single character error results in a failure to obtain desired translation results.

Accordingly, it would be advantageous to have a software system that practitioners and their staff can use on an as-needed basis, solely for the searches and translations they require. It would also be advantageous for the software system to be constantly updated with the most current version and release of terminology. And it would be advantageous to have software that enables practitioners and their staff to enter inexact terminology, such as spelling or syntax errors, and still obtain the desired translation results.

### BRIEF SUMMARY OF THE INVENTION

The present invention solves these problems by creating a cloud-based software system that practitioners and their staff can use on an as-needed basis, without the need to house software on their computers. Practitioners subscribe to the service and pay either a monthly access fee or a per-use fee. The software is accessible through a secure website and also through as set of web services so that these can be incorporated into any application

Because the software and medical-terminology libraries are housed on the software company's server, it may be updated immediately to include new and changed terminology and codes. To accomplish this, data structures are created that enable information indicating whether new data is being entered or data changed, identifying locations in the database base where additions or changes need to be made, and the new or substituted data.

In addition to providing easy access to accurate information in real time, the cloud-based model extends the terminology management and translation capabilities across broader boundaries. Local software versions of the prior art restrict users by preventing others outside one's organization where the software is housed. The software as a service (SaaS) system enable translations to extend beyond the “four walls” of one's business, allowing the terminologies and translations to be shared by many different companies or organizations.

To avoid the problem of failing to obtain results when inexact terminology is entered into the software by practitioners or their staff, a semantic data structure and path is used to calculate a probability that a particular entry matches particular terminology in the database library. The most likely correct answer is then used based on these probabilities, and the user obtains the translation for a particular entry.

One key feature of the process for the semantic data structure is to provide concepts for particular terminologies. Many terms have multiple meanings, and can result in inaccurate mapping from database entries during translation. For example, the word “cold” can mean temperature, or can mean the diagnosis of the common cold. Similarly, there are about 20 different codes for “hives” and 37 different ways to define “heart attack.” Once concepts are created, terminology can be mapped according to these concepts to ensure accurate results.

The core process for allowing semantic mappings is to provide real-time mapping and translations using the most advanced heuristics and knowledge-based tools. The process involves normalizing data to unique concepts and translating to clinical terminology codes, and providing the capability to map a free-text description to code/concept accurately and measure the closeness of different concepts to provide appropriate matching suggestions.

### BRIEF DESCRIPTION OF THE SEVERAL VIEWS OF THE DRAWINGS

The accompanying drawings illustrate the invention, where like reference numerals indicate the same feature throughout the drawings:

FIG. 1 shows a representation of the cloud-based software system of the present invention;

FIG. 2 shows a representation of the multi-layer information protocol from the internet protocol layer to the medical terminology layer of the data structures of the present invention; and

FIG. 3 shows a flow chart of the translation process for determining synonyms of medical terminology of the present invention.

### DETAILED DESCRIPTION OF THE INVENTION

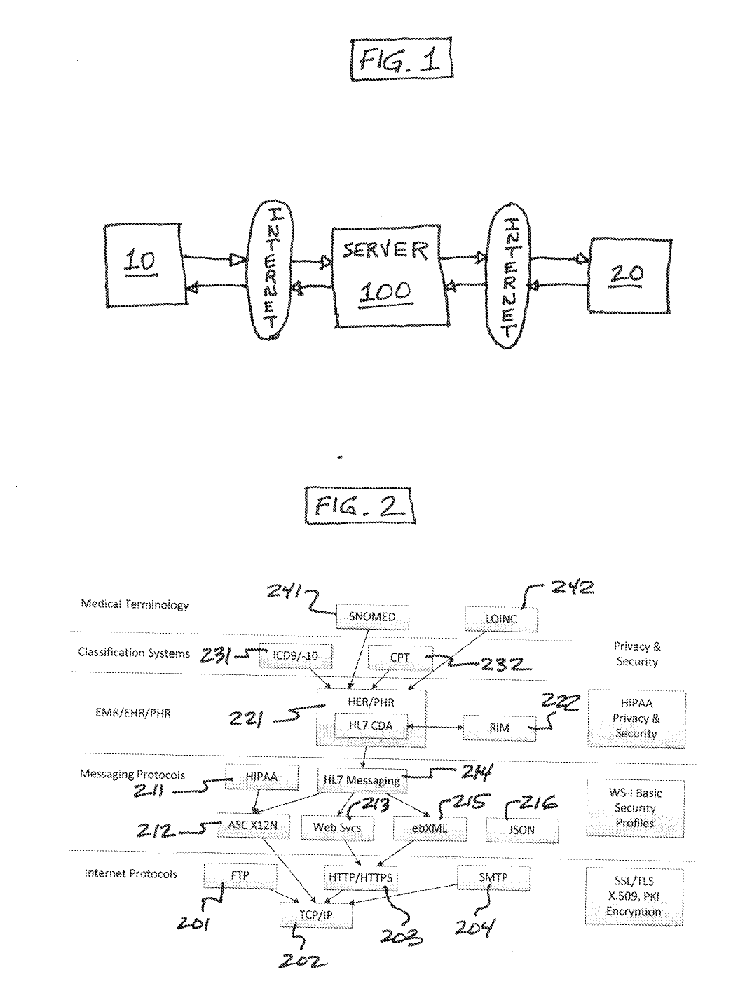

The drawings are for illustrative purposes of the preferred embodiment of the present invention. In FIG. 1, the cloud-based software system is depicted in which software provider computer 10 transmits the software and initial medical database to server 100 via the Internet. Software provider computer 10 is also used to send commands and information periodically to update additions, deletions and amendments to the database. Alternately, the software provider may directly program server 100 without using the Internet.

Consumer computer 20 transmits commands to server 100 via a webpage generated by server 100 to allow the consumer to subscribe to the software service, and to initiate a medical translation request. It will be obvious to those skilled in the art how to enable users to subscribe to software service, which could be payable on a per-use basis, or yearly, monthly or over any other period of time.

After the consumer has subscribed to the service, consumer computer 20 sends the medical terminology the consumer desires translated—along with information of the form or type of terminology in which the information is sent, and the desired form or type of terminology the user desires returned—to server 100 via the Internet. The software on server 100 processes the information request, and returns the translated terminology in the desired format or type.

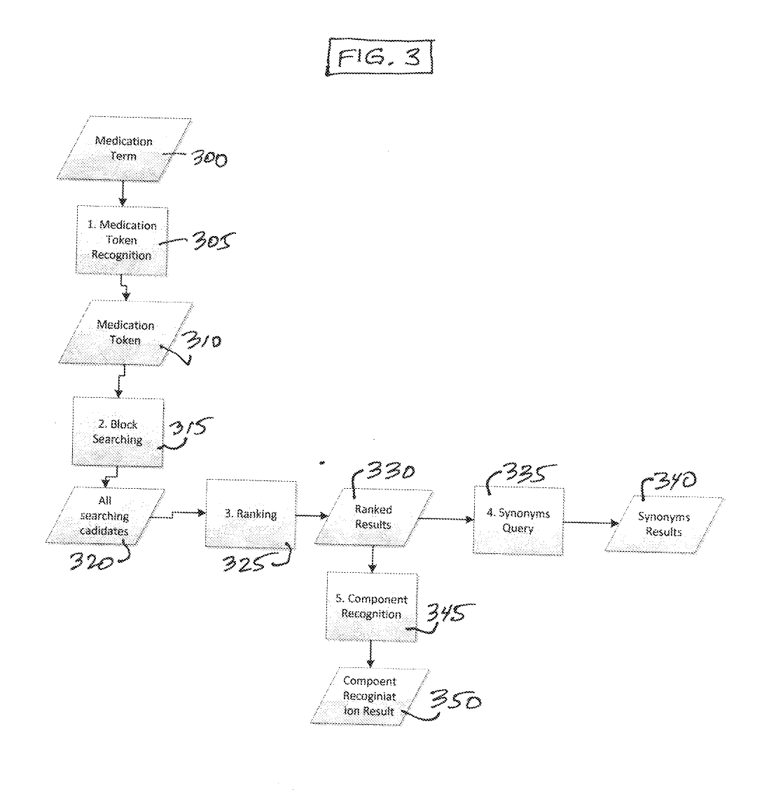

FIG. 2 shows a representation of the multiple layers of protocols for various data types, along with the corresponding security features. At the lowest or first level, we have internet protocols that permit communication over a set of networking protocols to allow parties to exchange messages. This includes FTP 201, TCP/IP 202, HTTP/HTTPS 203 and SMTP 204—all of which are well known in the art. The data on this level is encrypted for security using SSL/TLS X.509, PKI Encryption, which is also well known in the art.

The next layer up is the messaging protocols, which encodes messages into well-defined data structures that may be exchanged over the internet protocols. This includes HIPAA 211 (Health Insurance Portability and Accountability Act), ASC X12N 212 (Accredited Standards Committee), Web Services 213, HL7 Messaging 214 (Health Level Seven), ebXML 215 (Electronic Business using eXtensible Markup Language) and JSON 216 (JavaScript Object Notation). They are protected by WS-I basic security profiles.

The third layer is the medical terminology domains, which includes electronic medical records (EMR), electronic health records (EHR) and personal health records (PHR). Messages at this level are constructed or parsed by the EMR/EHR/PHR sending and receiving systems. The EMR/EHR/PHR may use standard database structures based on HL7 CDA 221 or RIM 222 or others to store the patient data. These electronic records must comply with HIPAA privacy and security requirements.

The fourth layer is the classification systems, which includes ICD-9 and ICD-10 (International Classification of Diseases) and CPT 232 (Current Procedural Terminology).

Finally, the top layer comprises medical terminology protocols, which consist of SNOMED 241 (SNOMED Clinical Terms), RxNorm and LOINC 242 (Logical Observation Identifiers Names and Codes).

The medical terminology domain level (the third layer) comprises healthcare messages that are clinical concepts that are represented by terminologies and vocabularies of different classification systems or medical terminology domains. These terminologies and vocabularies must be synchronized to enable effective communication between the EMR/EHR/PHR systems. For example, if the sending party wishes to convey a clinical observation to a receiving party, the observation type and observation values need to be represented using a set of clinical concepts, which must be drawn from a common set of standard terminologies. If the sending and receiving systems do not code clinical concepts using the same terminologies, then the source terminology needs to be translated to the target terminology so that the messages exchanged can be interpreted correctly.

The data structures used for the service interfaces for the terminology management include: administrative functions; terminology authoring; value set authoring; concept domain and usage context authoring; association authoring operations; search and access operations; value set search and access; concept domain and usage context search and access; and association-related queries.

The “administrative functions” include: import code system; import code system revision; import value set version; import association version; export association; export code system content; change code system status; register for notification; update notification registration; and update notification registration status.

The “import code system” is an interface that installs a code system or terminology for subsequent access by other service functions. It provides the initial installation of the overall terminology structure, including the full set of concepts, entities, relationships and other parameters. The contents may be supplied by value or reference, that is, as a complete set of explicit content or as a reference to a location where the content may be separately obtained for loading. The input parameters are: Code System ID; Code System Description (optional); Code System Administrative Information (optional); Code System Version; and Code System Contents. The Code System Contents parameter includes the source location (URI) or code system contents, such as concepts, concept properties, concept associations and designations.

The “import code system revision” is an interface that either installs an entire new version of the installation (that is, that installed by the import code system described above), or updates for the installation. Updates include new terminology, such as a new pharmaceutical, or modifications to the code system or terminology. The import code system includes an indicator that determines whether the entire installation is replaced or just some elements. The input parameters are: Code System Revision Source ID; Code System ID; Current Code System Version ID (optional); New Code System Version (class): Scope of Replacement (encoded and description); Code System Location (URI); and Updated Contents (e.g., concepts, concept properties, concept associations and designations).

The “import value set version” is an interface that installs a value set version into the terminology service for subsequent access by other service functions. This operation may also be used for the initial installation of the value set. The contents of the value set may either be explicitly provided or resolved at run-time where the value set is defined as a computable expression. The input parameters are: Value Set ID; Value Set Description (optional); Value Set Administrative Information (optional); Value Set Version (see model for class description); and Value set Contents (ruleSetID).

The “import association version” is an interface that installs a set of code-system associations or mappings into the terminology service for subsequent access by other service functions. This operation may be used for the initial installation of a set of associations, which may include the full set of associations between concepts from different code systems. The actual associations may be supplied by value or reference as a complete set of explicit associations or as a reference to a location where the associations may be separately obtained for loading. The input parameters are: Association (set) Identifier; Association Description (optional); Association Administrative Information (optional); Association Version (optional); and Association Location (URI). Alternately, the last parameter may comprise Association Contents, including concepts, concept association type, and concept associations (i.e., maps).

The “export association” is an interface to export association type instances from a code system applying filter criteria. The input parameters are: Code System ID; Code System Version ID; Association Type(s); Filter Criteria (optional); and Export Format.

The “export code system content” is an interface that exports a terminology or code system subset criteria. This criteria consists of a specific set of concepts and associations—or maps—from server 100 by filtering the content and converting it to the requested format for export. This is performed in accordance with the semantic profile of the deployment jurisdiction. This is the heart of the translation function of the software system. The input parameters are: Code System ID; Code System Version ID; Code System Filter Criteria; Export Format; and Target Location (URI).

The “change code system status” is an interface that changes the state of a code system. It includes activation and inactivation, and allows a terminology administrator to manage the availability for access by other terminology service functions. The input parameters are Code System Identifier; Code System Version; and Code System Status.

The “register for notification” is an interface that receives notifications of modifications to a vocabulary element, such as a code system, value set, concept or relationship. The input parameters are URL (or other electronic address to send the terminology element modification notification); Notification Target Type (code system, value set, concept, concept relationship); Notification Target Identifier; Notification Target Version and Notification Directions. The Notification Directions parameter is a placeholder for providing specific directions for the notification, such as whether notification should be made immediately or be delayed.

The “update notification registration” is an interface that revises a notification entry for a particular vocabulary element. The input parameters are: Notification Entry Identifier; URL (or other electronic address to send the terminology element modification notification); Notification Target Type (code system, value set, concept, concept relationship); Notification Target Identifier; Notification Target Version and Notification Directions.

The “update notification registration status” is an interface that changes the status of a notification entry for a particular vocabulary element, such as suspending, reinstating, canceling or removing an vocabulary element. The input parameters are Notification Entry Identifier and Notification Status.

The “terminology authoring” includes: create code system, maintain code system version; update code system version status, create code system supplement; maintain code system supplement; create concept; maintain concept; update concept status; create association type; and maintain association type.

The “create code system” is an interface that creates a new code system to contain a set of new coded concepts by defining a set of metadata that describes itself. The input parameters are: Code System Name; Code System Version; and Code System Properties.

The “maintain code system version” is an interface that updates the code system metadata properties. The input parameters are Code System ID; Code System Name; Code System Version; Code System Properties; Set of Zero or More Concepts (IDs, properties and designations); and Set of Zero or More Concept Associations.

The “update code system version status” is an interface that changes the status of a code system version to suspend, reinstate, cancel or remove it. The input parameters are: Code System Identifier; Code System Version; and Status.

The “create code system supplement” is an interface that creates a new code system supplement as a container of a set of concepts and concept properties to be appended to a target code system. Note that it does not add the concepts and properties. The input parameters are Target Code System ID; Code System Supplement Description; Code System Supplement Provenance Details; Code System Supplement Effective Data; and Code System Supplement Name.

The “maintain code system supplement” is an interface that updates the code system supplement metadata properties to add concepts and properties to the code system. The input parameters are: Code System Property ID; Code System Supplement Name; Code System Supplement Description; Code System Supplement Provenance Details; Code System Supplement Effective Date; Set of Zero or More Concepts; and Set of Zero or More Concept Properties.

The “create concept” is an interface that creates concepts to be included in a code system. The new concept is defined by a set of metadata properties that describe it. It may include its proper placement via association binding within the hierarchy of the code system. The input parameters are: Code System ID; Code System Version; Concept Code; Concept Identifier or Concept Code (optional); Concept Properties; (Allowable) Concept Relationships; and Concept Designations.

The “maintain concept” is an interface that updates concept metadata properties. The input parameters are: Code System ID; Concept Code; Concept ID; Concept Version ID; Jurisdictional Domain ID (optional); Concept Properties; (Allowable) Associations; and Concept Designations.

The “update concept status” is an interface that changes the status of a code system concept to suspend, reinstate, cancel or remove the concept. The input parameters are: Code System Identifier; Concept Code; Concept Version ID; and Status.

The “create association type” is an interface that creates a new relationship type as intended by the association type class of the conceptual model. A list of code system IDs may be supplied to restrict use to specific code systems, although the default is to allow availability to all codes systems on server 100. The input parameters are: Association Type ID (optional); Association Type Name; Association Type Properties; and List of Zero or More Code System IDs.

The “maintain association type” is an interface that updates or deprecates an association type that may be used to link two concepts. The input parameters are: Association Type ID; Association Type Name; Association Type Properties; List of Zero or More Code System IDs; and Association Type Status.

The “value set authoring” includes: create value set; maintain value set; and update value set status.

The “create value set” is an interface that creates a value set (extensional or intensional) that is defined by a computable expression. The value set may consist of an exact list of coded concepts at any given point in time. The input parameters are: Value Set Name (optional); Value Set Id (mandatory); Value Set Version; Value Set Properties; Value Set Rule Set (which may be an enumeration, i.e. an extensional value set); Value Set Date Lock (Boolean); and Value Override (optional, for extensional definitions).

The “maintain value set” is an interface that updates properties or expressions of a value set definition (extensional and intensional value sets). The input parameters are: Value Set ID (mandatory); Value Set Name (optional); Value Set Version; Value Set Properties; Value Set Rule Set (which may be an enumeration, i.e. an extensional value set); and Value Set Date Lock (Boolean).

The “update value set status” is an interface that changes the status of a value set version to suspend, reinstate, cancel or remove the value set. The input parameters are: Value Set Identifier; Value Set Version; and Status.

The “concept domain and usage context authoring” includes create concept domain; maintain concept domain; create usage context; and maintain usage context.

The “create concept domain” is an interface that creates a concept domain. The input parameters are: Concept Domain Name; Concept Domain ID (optional); and Concept Domain Properties.

The “maintain concept domain” is an interface that updates the properties of a concept domain, including implementing bindings to value sets within usage contexts. The input parameters are: Concept Domain ID; Concept Domain Name; Concept Domain Properties; Concept Domain Status; Set of Zero or More Pairs of Value Set ID; and Usage Context ID.

The “create usage context” is an interface creates a usage context. The input parameters are: Usage Context Name; Usage Context ID (optional); and Usage Context Properties.

The “maintain usage context” is an interface that updates properties of a usage context. The input parameters are: Usage Context ID; Usage Context Name; Usage Context Properties; and Usage Context Status.

The “association authoring operations” include create association and update association status. The “create association” is an interface that relates a single specific coded concept in a specified code system or source to a corresponding single specific coded concept or target within the same or another code system. The interface identifies a specified association type. The input parameters are: Source code system Identifier; Target Code System Identifier; Source Concept Code/Identifier; Target Concept Code/Identifier; Association Type; and Association Properties. The “update association status” is an interface that activates, deactivates, cancels or otherwise changes the status of an association. This enables a terminology user to change an association availability for access by other terminology service functions. The input parameters are: Association Identifier; Association Version ID; and Status.

The “search and access operations” include: list code systems; return code system details; list code system concepts; return concept details; list association types; and return association type details.

The “list code systems” is an interface that lists the code systems available on the CTS2 Service that matches the designated filter criteria. The Input parameters are Filter Criteria and Query Control.

The “return code system” details is an interface that returns the details (metadata) for a given code system available on the terminology service. The input parameters are Code System Identifier and Code System Version.

The “list code systems concepts” is an interface that returns a set of all concepts and concept codes in the specified code system. It provides the option to filter input criteria, such as state or specific concept property values. The input parameters are: Code System Identifier; Code System Version; Filter Criteria; and Query Control.

The “return concept details” is an interface that returns the details for the known attributes (metadata) of a coded concept. The input parameters are: Code System Identifier; Code System Version ID; Concept Identifier; and Concept Version ID.

The “list association types” is an interface that lists association types that are available on a server 100 that matches designated filter criteria (e.g. code system, code system version). The input parameters are Filter Criteria and Query Control. And the “return association type details” is an interface that returns the details for the known attributes (metadata) of a relationship type. The input parameter is Association Type ID.

The “value set search and access” includes: list value sets; return value set details; check value set subsumption; and check concept value set membership.

The “list value sets” is an interface that provides a list of the value sets available to the Common Terminology Services 2 (CTS 2). The input parameters are Value Set Filter Criteria and Query Control. The return value set details is an interface that looks up detailed information (metadata) for a given value set. The input parameters are Value Set Identifier and Value Set Version.

The “list value set contents” is an interface that expands the value set. It provides a list of the contents or entries of a particular value set filtering based on particular input criteria. The input parameters are: Value Set Identifier; Value Set Version (optional); Value Set Time Stamp (optional); Filter Criteria; and Query Control.

The “check value set subsumption” is an interface that determines whether one of the two supplied value sets subsumes the other. The input parameters are a pair of two conjunctions—Value Set Identifier and Value Set Version.

The “check concept value set membership” is an interface that determines whether the supplied coded concept exists in the supplied value set. The input parameters are: Code System Identifier; Code System Version (optional); Concept Identifier or Concept Code; Value Set Identifier; and Value Set Version.

The “concept domain and usage context search and access” includes: list concept domains; return concept domain details; list usage contexts; return usage context details; list concept domain bindings; and check concept-to-concept domain association.

The “list concept domains” is an interface that lists the concept domains available to the CTS 2 service. The input parameters are Concept Domain Filter Criteria and Query Control. The “return concept domain details” is an interface that looks up detailed information (metadata) for a given concept domain. The input parameter is a Concept Domain Identifier.

The “list usage context” is an interface that provides a list of the usage contexts that are available to the CTS 2 service. The input parameters are Usage Context Filter Criteria and Query Control. The “return usage context details” is an interface that looks up detailed information (metadata) for a given usage context. The input parameter is a Usage Context Identifier.

The “list concept domain bindings” is an interface that provides a list of the value set identifier and metadata for the specified domain bindings. This does not include returning the value set expansion. The input parameters are: Concept Domain Identifier; Filter Criteria; and Query Control.

The “check concept-to-concept domain association” is an interface that determines whether the particular coded concept exists in a code system in use for the specified concept domain. This optionally may be limited to specific usage contexts. It returns “true” if a coded concept is an element of a value set expansion bound to the particular concept domain, or bound to both the concept domain and usage context. The input parameters are: Code System Identifier; Concept Identifier or Concept Code; Concept Domain Identifier; and List of Usage Context Identifiers (optional).

The “association-related queries” include list associations and determine transitive concept relationship. The “list associations” is an interface that lists the associations available on the CTS 2 service that matches a set of input filter criteria. The input parameters are Filter Criteria and Query Control. The “determine transitive concept relationship” is an interface that determines whether a transitive relationship exists between two concepts. If so, it provides the association path. For example, it determines whether it is possible to get from a given parent code system node into a given child code system node in one or more association transitions. The input parameters are: ParentCodeSystemNodeID (support for compositional expression optional); ChildCodeSystemNodeID (support for compositional expressions optional); and ConceptAssociationType.

A key feature of the present invention is the translation manager, which maps or translates terminology between standard medical vocabularies, such as RxNorm and SNOMED. The translation manager provides all synonyms of a free-text medication term, recognizes the different components of a free-text medication term, and compares the semantic similarity between two medication terms. The interfaces are: GetConceptSynonyms(“Free-text Term 1”); GetNormalizedDrugAttributes(“Free-text Term 2”); and GetConceptSimilarity(“Free-text Medication Term 1”, “Free-text Term2”).

The translation process for determining synonyms is depicted in FIG. 3. Medication term 300 is a full-text medication term that is tokenized by medication-token recognition 305 to yield medication token 310. This step recognizes the key medication name based on a pre-build medication dictionary. The tokenization process has been completed by Lucene core library, and the dictionary is based on UMLS medication vocabulary. The interface parameter for medication term 300 and medication token 310 is GetToken(“Free-text Term 1”).

For example, if medication term 300 is “Naproxen Tab 250 MG,” the key token is “Naproxen,” the medication name. Note that if medication term 300 has a misspelled word, the semantic translation process—which is described more fully below —autocorrects the spelling error by finding the best match in the dictionary. “Neproxen Tab 250 MG” thus becomes “Naproxen.”

The next step in the translation process is block searching 315, where the UMLS database is searched to find all concept synonyms—that is, all searching candidates 320—that contain the string of medication token 310. In UMLS, each unique concept has a unique ID, but one unique ID has more than one synonym. In this searching step, we perform an SQL-like query to get all UMLS concepts (each concept contains more than one synonym), and their synonyms contain medication token 310, List<Concepts>GetListOfCadidates(token 310), where Concept Object contains concept ID and a list of synonyms. There may be more than one synonym for any medication token 310.

The third step is to rank searching candidates 320 that contain medication token 310 and apply RxNorm approximation matching to attain a rank for rank searching candidates 320 using the Jaccard-coefficient similarity calculation. The output of this step is an ordered list of concepts. Further details for these steps can be found at http://rxnav.nlm.nih.gov/RxNormApproxMatch.html, which is incorporated by reference. For almost all application of the RxNorm approximation matching, the top-ranked concept—ranked results 330—is the one the user intended. Note that RxNorm provides normalized names for clinical drugs and links its names to many of the drug vocabularies commonly used in pharmacy management and drug interaction software, including those of First Databank, Micromedex, MediSpan, Gold Standard Drug Database, and Multum. By providing links between these vocabularies, RxNorm can mediate messages between systems not using the same software and vocabulary. The UMLS library contains the RxNorm data set.

Returning to our example, when querying “Naproxen Tab 250 MG” as medication term 300, synonym results 340 consist of partial output xml as shown below. The unique concept ID is “C0689728” in the code system “RxNorm.” As we mentioned we can get a list of ranked concepts. In practice users only care about the closest match, which shows on the top of the list. Unique concept ID is part of concept object, which originates from the UMLS database. Note that synonym results 340 include synonyms like “NAPROXEN 250 MG ORAL TABLET”, “NAPROXEN 250 mg ORAL TABLET [Naproxen]”, and so forth. In another code system, “SNOMEDCT,” it shows as other synonyms. The code for the querying is:

<ConceptSynonym>

<cui>C0689728</cui>
<Datasource>

<datasourceName>RXNORM</datasourceName>
<synonym>NAPROXEN 250 MG Oral (systemic) tablet</synonym>

</Datasource>
<Datasource>

<datasourceName>RXNORM</datasourceName>
<synonym>NAPROXEN 250 MG ORAL TABLET</synonym>

</Datasource>
<Datasource>

<datasourceName>RXNORM</datasourceName>
<synonym>NAPROXEN 250 mg ORAL TABLET [Naproxen]</synonym>

</Datasource>
<Datasource>

<datasourceName>RXNORM</datasourceName>
<synonym>Naproxen 250 MILLIGRAM In 1 TABLET ORAL

TABLET</synonym>

</Datasource>
<Datasource>

<datasourceName>RXNORM</datasourceName>
<synonym>NAPROXEN 250MG ORAL TABLET</synonym>

</Datasource>
<Datasource>

<datasourceName>RXNORM</datasourceName>
<synonym>NAPROXEN 250MG TAB</synonym>

</Datasource>
<Datasource>

<datasourceName>RXNORM</datasourceName>
<synonym>NAPROXEN 250MG TAB,UD</synonym>

</Datasource>
<Datasource>

<datasourceName>RXNORM</datasourceName>
<synonym>NAPROXEN 250MG TABLET</synonym>

</Datasource>
<Datasource>

<datasourceName>RXNORM</datasourceName>
<synonym>NAPROXEN@250MG@ORAL@TABLET</synonym>

</Datasource>
<Datasource>

<datasourceName>SNOMEDCT</datasourceName>
<synonym>Naproxen 250mg tablet</synonym>

</Datasource>
<Datasource>

<datasourceName>SNOMEDCT</datasourceName>
<synonym>Naproxen 250mg tablet (product)</synonym>

</Datasource>
<Datasource>

<datasourceName>SNOMEDCT</datasourceName>
<synonym>Naproxen 250mg tablet (substance)</synonym>

</Datasource>
<Datasource>

<datasourceName>VANDF</datasourceName>
<synonym>NAPROXEN 250MG TAB</synonym>

</Datasource>
<Datasource>

<datasourceName>VANDF</datasourceName>
<synonym>NAPROXEN 250MG TAB UD</synonym>

</Datasource>
<Datasource>

<datasourceName>VANDF</datasourceName>
<synonym>NAPROXEN 250MG TAB,UD</synonym>

</Datasource>
<matchingSynonym>Naproxen Tab 250 MG</matchingSynonym>

</ConceptSynonym>

Another example of the translation process pertains to the work flow of drug component recognition. Returning to FIG. 3, the first three steps—from medication term 300 through ranked results 330—are performed the same as in the above example. However, instead of the fourth step with synonym query 335 and synonym results 340, the fifth step is performed in which ranked results 330 is used to obtain the unique concept ID through component recognition 345, yielding component recognition results 350.

After the unique concept ID is obtained, RxNorm descriptions are searched for various components of the searching term, such an ingredient and strength. Component recognition result 350 is the xml results for “Naproxen Tab 250 MG” in the following code:

<NormDrug>

<isPack>false</isPack>
<cui>C0689728</cui>
<NormIngredient>

<ingredientName>Naproxen</ingredientName>
<conceptId>C0027396</conceptId>
<strength>250 MG</strength>

</NormIngredient>
<doseForm>Oral Tablet</doseForm>

</NormDrug>

The same process is employed for a similarity computation. Given two terms, the system will perform steps 1-3 (medication term 300 through ranked results 330) as discussed above, and obtain the top unique concept ID as the best match for each term. Then the system will reply on the YTEX similarity to compute the similarity value of these two unique IDs. The result is number ranging from 0 to 1. 1 means the same and 0 means completely unrelated. Further detail on the semantic similarity computation may be found at https://code.google.com/p/ytex/wiki/SemanticSim_V06, which is incorporated by reference herein.

Various other modifications may be made to that depicted in the various drawings of the preferred embodiment of the present invention without departing from the spirit and scope of the invention. Accordingly, the invention is not to be limited by the preferred embodiment shown in the various drawings and described herein, but by the scope of the claims.

1. A cloud-based medical terminology management and translation system comprising:
a remote server housing medical terminology libraries and system software;
an end-user computer that accesses the remote server through an internet;
a medical terminology database having sets of medical terminology and housed on the remote server; and
software having a database structure and a translation manager;
wherein the software employs concepts for particular medical terminology that can relate to other medical terminology sharing the same concept; and
wherein the translation manager maps one set of medical terminology onto another set.

2. The cloud-based medical terminology management and translation system of claim 1 in which the database structure further comprises:
an entry designating whether data in the database structure is to be added or changed;
an entry designating the location of the data to be added or changed; and
an entry designating the added or changed data.

3. The cloud-based medical terminology management and translation system of claim 1 in which the translation manager calculates the probability that an entry matches a particular medical terminology in the database library, and uses the most likely correct answer based on the probabilities.

4. The cloud-based medical terminology management and translation system of claim 1 in which the translation manager maps standard medical terminologies for a free-text entry, provides synonyms of medical terminologies, recognizes different components of a free-text entry, and compares the similarities between the medical terminologies.

5. The cloud-based medical terminology management and translation system of claim 4 in which the translation manager calculates the probability that an entry matches a particular medical terminology in the database library, and uses the most likely correct answer based on the probabilities.

6. The cloud-based medical terminology management and translation of claim 1 in which the database structure has multiple domain layers.

7. The cloud-based medical terminology management and translation system of claim 6 in which the translation manager calculates the probability that an entry matches a particular medical terminology in the database library, and uses the most likely correct answer based on the probabilities.

8. A cloud-based medical terminology management and translation system comprising:
a remote server housing medical terminology libraries and system software;
an end-user computer or microprocessor that accesses the remote server through an internet;
a medical terminology database having sets of medical terminology and housed on the remote server; and
software having a database structure and a translation manager;
wherein the translation manager maps one set of medical terminology onto another set; and
wherein the translation manager calculates the probability that an entry matches a particular medical terminology in the database library, and uses the most likely correct answer based on the probabilities.

9. The cloud-based medical terminology management and translation system of claim 8 in which the database structure further comprises:
an entry designating whether data in the database structure is to be added or changed;
an entry designating the location of the data to be added or changed; and
an entry designating the added or changed data.

10. The cloud-based medical terminology management and translation of claim 9 in which the database structure has multiple domain layers.

11. The cloud-based medical terminology management and translation system of claim 8 in which the translation manager maps standard medical terminologies for a free-text entry, provides synonyms of medical terminologies, recognizes different components of a free-text entry, and compares the similarities between the medical terminologies.

12. The cloud-based medical terminology management and translation system of claim 11 in which the database structure has multiple domain layers.

13. The cloud-based medical terminology management and translation of claim 8 in which the database structure has multiple domain layers.

14. A process for semantic mappings in a cloud-based medical terminology management translation system having the steps of:
normalizing data entries in a database library sets to unique concepts;
translating data entries in a database library to clinical terminology codes;
mapping a free-text description entry to a particular code and concept; and
measuring the closeness of different concepts to provide the best probability match.

15. The process for semantic mappings in a cloud-based medical terminology management translation system of claim 14 in which a database structure for the medical terminology and translation system has multiple domain layers.
